(19) United States
(12) Patent Application Publication
(10) Pub. No.: US 2015/0271471 A1
(43) Pub. Date: Sep. 24, 2015

(54) BLOCKING DETECTION METHOD FOR CAMERA AND ELECTRONIC APPARATUS WITH CAMERAS

(71) Applicant: HTC Corporation, Taoyuan County (TW)

(72) Inventors: Chung-Hsien HSIEH, Taoyuan County (TW); Ming-Che KANG, Taoyuan County (TW)

(73) Assignee: HTC Corporation, Taoyuan County (TW)

(21) Appl. No.: 14/294,175

(22) Filed: Jun. 3, 2014

Related U.S. Application Data
(60) Provisional application No. 61/955,219, filed on Mar. 19, 2014.

(51) Int. Cl. H04N 13/02; G06T 7/00; H04N 5/232

(52) U.S. Cl. CPC H04N 13/0239; H04N 13/0246; H04N 5/23293; G06T 7/002

(57) ABSTRACT

A method, suitable for an electronic apparatus with a first camera and a second camera, is disclosed for detecting whether the second camera is blocked accidentally. The method includes following steps. A first image is sensed by the first camera and a second image is sensed by the second camera simultaneously. A first brightness evaluation result is generated from the first image and a second brightness evaluation result is generated from the second image. Whether the second camera is blocked or not is determined according to a comparison between the first brightness evaluation result and the second brightness evaluation result.

### CROSS-REFERENCE TO RELATED APPLICATION

This application claims the priority benefit of U.S. Provisional Application Ser. No. 61/955,219, filed Mar. 19, 2014, the full disclosures of which are incorporated herein by reference.

### FIELD OF INVENTION

The disclosure relates to a photography method/device. More particularly, the disclosure relates to a method of detecting whether a camera is blocked.

### BACKGROUND

Photography used to be a professional job, because it requires much knowledge in order to determine suitable configurations (e.g., controlling an exposure time, a white balance, a focal distance) for shooting a photo properly. As complexity of manual configurations of photography has increased, required operations and background knowledge of user have increased.

Stereoscopic image is based on the principle of human vision with two eyes. One way to establish a stereoscopic image is utilizing two cameras separated by a certain gap to capture two images, which correspond to the same object(s) in a scene from slightly different positions/angles. The X-dimensional information and the Y-dimensional information of the objects in the scene can be obtained from one image. For the Z-dimensional information, these two images are transferred to a processor which calculates the Z-dimensional information (i.e., depth information) of the objects to the scene. The depth information is important and necessary for applications such as the three-dimensional (3D) vision, the object recognition, the image processing, the image motion detection, etc.

In order to do the depth computation or other three-dimensional applications, the information captured by two cameras are both required. If one of these two cameras is blocked (e.g., accidentally covered by user's finger), the images from two cameras will not be coordinated, such that the following computations/applications will fail.

### SUMMARY

An aspect of the disclosure is to provide a method, suitable for an electronic apparatus with a first camera and a second camera, is disclosed for detecting whether the second camera is blocked accidentally. The method includes following steps. A first image is sensed by the first camera and a second image is sensed by the second camera simultaneously. A first brightness evaluation result is generated from the first image and a second brightness evaluation result is generated from the second image. Whether the second camera is blocked or not is determined according to a comparison between the first brightness evaluation result and the second brightness evaluation result.

Another aspect of the disclosure is to provide an electronic apparatus, which includes a first camera, a second camera, a display panel and a processing module. The first camera is configured for pointing in a direction and sensing a first image corresponding to a scene. The second camera is configured for pointing in the same direction and sensing a second image substantially corresponding to the same scene. The display panel is configured for displaying the first image as a preview image. The processing module is coupled with the first camera and the second camera. The processing module is configured for generating a first brightness evaluation result from the first image and a second brightness evaluation result from the second image, and determining whether the second camera is blocked according to a comparison between the first brightness evaluation result and the second brightness evaluation result.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A and FIG. 1B are a back view diagram and a front view diagram illustrating an electronic apparatus according to an embodiment of the disclosure.

FIG. 2 is a functional block diagram illustrating the electronic apparatus shown in FIG. 1A and FIG. 1B.

FIG. 3 is a flow chart diagram illustrating a method for detecting whether one camera within the dual camera configuration is blocked.

FIG. 4A and FIG. 4B are schematic diagrams illustrating a pair of images, including a first image sensed by the first camera and a second image by the second camera, taken by the dual camera configuration according to an embodiment of the disclosure in a scenario that the second camera is not blocked.

FIG. 5A and FIG. 5B are schematic diagrams illustrating a pair of images, including a first image sensed by the first camera and a second image by the second camera, taken by the dual camera configuration according to an embodiment of the disclosure in another scenario that the second camera is blocked.

FIG. 6 is a flow chart diagram illustrating a method for detecting whether one camera within the dual camera configuration is blocked.

FIG. 7A illustrates the first brightness distribution histogram corresponding to the first image IMG1a in FIG. 4A.

FIG. 7B illustrates the second brightness distribution histogram corresponding to the second image in FIG. 4B when the second camera is not blocked.

FIG. 8A illustrates the first brightness distribution histogram corresponding to the first image in FIG. 5A.

FIG. 8B illustrates the second brightness distribution histogram corresponding to the second image in FIG. 5B when the second camera is blocked.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

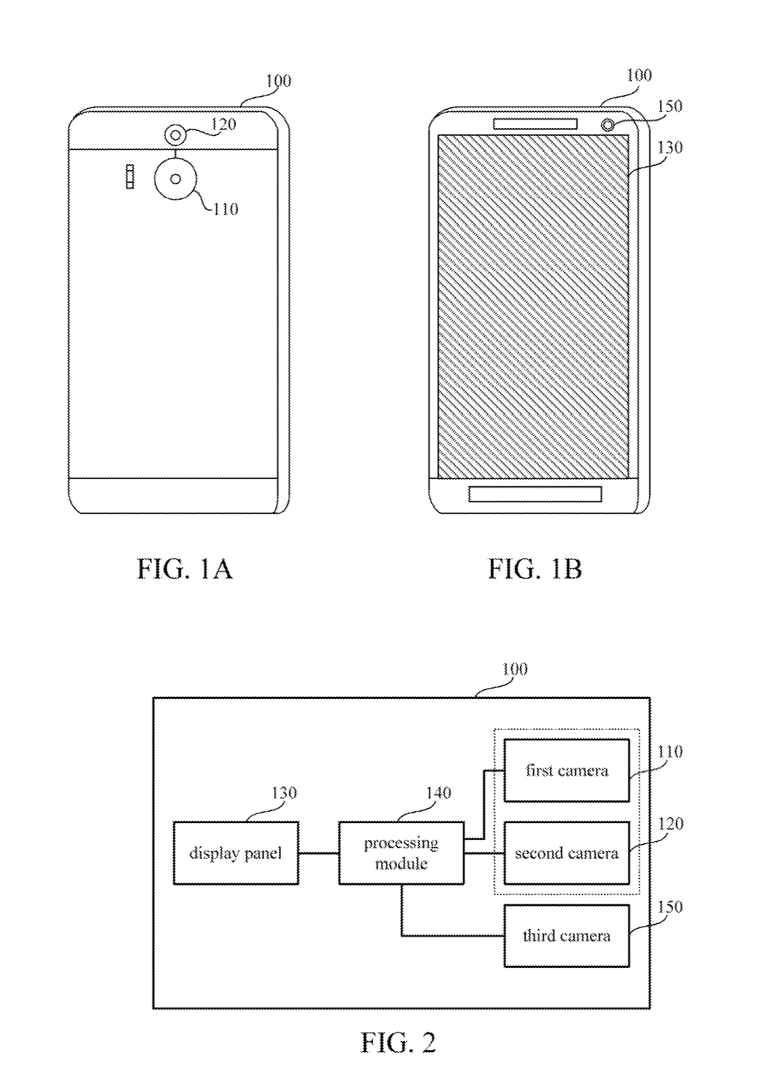

Reference is made to FIG. 1A, FIG. 1B and FIG. 2. FIG. 1A and FIG. 1B are a back view diagram and a front view diagram illustrating an electronic apparatus 100 according to an embodiment of the disclosure. FIG. 2 is a functional block diagram illustrating the electronic apparatus 100 shown in FIG. 1A and FIG. 1B. As shown in the figures, the electronic apparatus 100 in the embodiment includes a first camera 110, a second camera 120, a display panel 130 and a processing module 140. The display panel 130 is configured for displaying a user interface of the electronic apparatus 100.

In the embodiment, the first camera 110 is a main camera in a dual camera configuration and the second camera 120 is a subordinate camera (i.e., sub-camera) in the dual camera configuration. As shown in FIG. 1A, the first camera 110 and the second camera 120 within the dual camera configuration in this embodiment are both disposed on the same surface (e.g., the back side) of the electronic apparatus 100 and gapped by an interaxial distance. The first camera 110 is configured for pointing in a direction and sensing a first image corresponding to a scene. The second camera 120 point in the same direction and sensing a second image substantially corresponding to the same scene as the first camera 110 does. In other words, the first camera 110 and the second camera 120 are capable to capture a pair of images to the same scene from slight different viewing positions (due to the interaxial distance), such that the pair of images can be utilized in computation of depth information, simulation or recovering of three-dimensional (3D) vision, parallax (2.5D) image processing, object recognition, motion detection or any other applications.

In some embodiment, the first camera 110 and the second camera 120 adopt the same model of cameras, when the total cost is reasonable and the space on the electronic apparatus 100 allow the design (i.e., identical cameras are utilized in the dual camera configuration). In this embodiment shown in FIG. 1A, the first camera 110 and the second camera 120 of the dual camera configuration adopt different models of cameras. In general, the first camera 110, which is the main camera, may have better optical performances (e.g., larger optical sensor dimensions, better sensitivity, faster shutter speed, wider field of view and/or higher resolution), and the first image sensed by the first camera 110 is usually recorded as a captured image. On the other hand, the second camera 120, which is the subordinate camera, may have the same or relative lower optical performances, and the second image sensed by the second camera 120 is usually utilized as auxiliary data or supplemental data while processing image (e.g., the computation of depth information, the simulation or recovering of three-dimensional vision, the parallax image processing, the object recognition, motion detection, etc.).

When the dual camera configuration is triggered and operated to capture images, the first image sensed by the first camera 110 is usually displayed on the display panel 130 as a preview image, such that the user can acknowledge that what will be captured in the first image in real-time.

In general, the second image sensed by the second camera 120 will not be displayed on the display panel 130. Therefore, when the user accidentally block the second camera 120 (e.g., the user covers the second camera 120 by his finger while holding the electronic apparatus 100 by an inappropriate gesture), the user may not notice that the second camera 120 is currently blocked through the display panel 130, such that the second image sensed by the second camera 120 will be uncoordinated and mismatched from the first image sensed by the first camera 110, even the first/second images are sensed simultaneously by the first camera 110 and the second camera 120.

In some embodiments, the electronic apparatus 100 can further include a third camera 150. As shown in FIG. 1B, the third camera 150 is disposed on the front side of the electronic apparatus 100. The third camera 150 is not a part of the dual camera configuration. The third camera 150 can be triggered and utilized in functions of webcam streaming, video calling, self-portrait photographing, etc.

In this embodiment, the processing module 140 is coupled with the first camera and the second camera. The processing module 140 is configured for generating a first brightness evaluation result from the first image and a second brightness evaluation result from the second image. The first brightness evaluation result and the second brightness evaluation result are compared by the processing module 140. The processing module 140 is also configured for determining whether the second camera 120 is blocked according to the comparison between the first/second brightness evaluation results. The detail behaviors of how to evaluate and determine whether the second camera 120 is blocked or not are introduced in the following paragraphs.

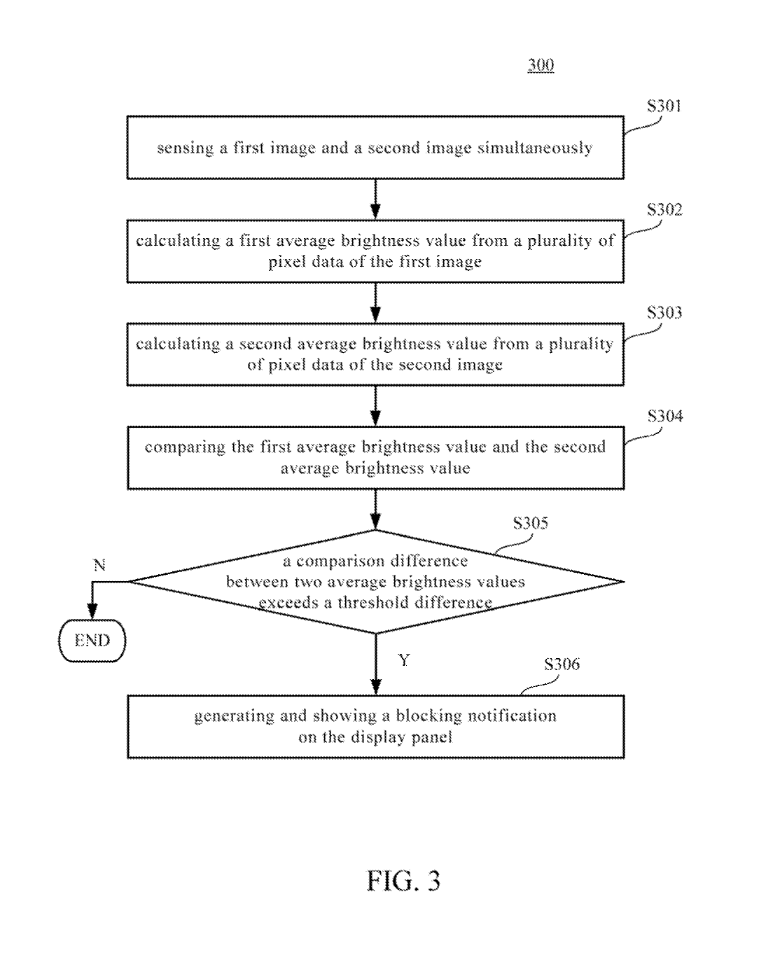

Reference is also made to FIG. 3, which is a flow chart diagram illustrating a method 300 for detecting whether one camera within the dual camera configuration is blocked. The method 300 is suitable to be utilized on the electronic apparatus 100 in aforesaid embodiments shown in FIG. 1A, FIG. 1B and FIG. 2. As shown in FIG. 3, the method 300 executes the step S301 for sensing a first image by the first camera 110 and a second image by the second camera 120 simultaneously.

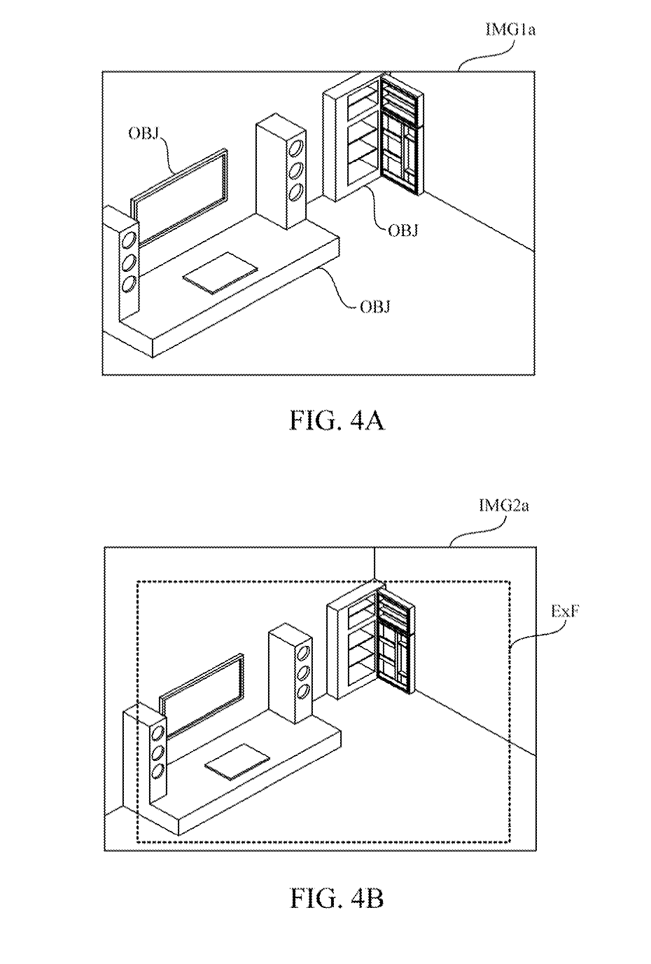

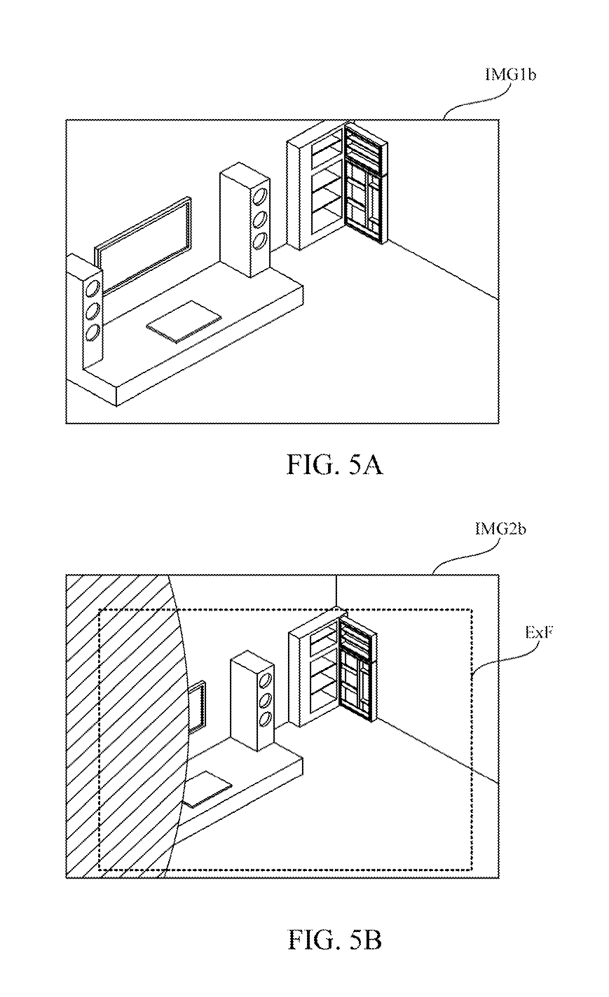

Reference is also made to FIG. 4A, FIG. 4B, FIG. 5A and FIG. 5B. FIG. 4A and FIG. 4B are schematic diagrams illustrating a pair of images, including a first image IMG1a sensed by the first camera 110 and a second image IMG2a by the second camera 120, taken by the dual camera configuration according to an embodiment of the disclosure in a scenario that the second camera 120 is not blocked. On the other hand, FIG. 5A and FIG. 5B are schematic diagrams illustrating a pair of images, including a first image IMG1b sensed by the first camera 110 and a second image IMG2b by the second camera 120, taken by the dual camera configuration according to an embodiment of the disclosure in another scenario that the second camera 120 is blocked.

As shown in FIG. 4A and FIG. 4B, the first image IMG1a sensed by the first camera 110 and the second image IMG2a by the second camera 120 are approximately the same (if the cameras adopt the same model) or at least highly similar (if the cameras adopt different models), because the first image IMG1a and the second image IMG2a are taken simultaneously by the dual camera configuration. In practices, the first image IMG1a and the second image IMG2a will have slight difference between each others due to the interaxial distance.

As shown in FIG. 3, the method 300 executes the step S302 for calculating a first average brightness value from a plurality of pixel data of the first image IMG1a/IMG1b as the first brightness evaluation result. For example, each pixel data in the first image IMG1a/IMG1b has a luminance value. In an embodiment, the luminance value of each pixel in the first image IMG1a/IMG1b can be obtained form the “Y” variable form a YUV (YCbCr) color code of the first image IMG1a/IMG1b. An average of the luminance values of all pixels in the first image IMG1a/IMG1b is calculated to be the first average brightness value (also regarded as the first brightness evaluation result of the first image).

The method 300 executes the step S303 for calculating a second average brightness value from a plurality of pixel data of the second image IMG2a/IMG2b as the second brightness evaluation result. For example, each pixel data in the second image IMG2a/IMG2b has a luminance value. An average of the luminance values of all pixels in the second image IMG2a/IMG2b is calculated to be the second average brightness value (also regarded as the second brightness evaluation result of the second image). In addition, the disclosure is not limited to a specific sequence of each step shown in FIG. 3 of this embodiment. For example, the order of the steps S302 and S303 can be swapped in some other embodiments.

The method 300 executes the step S304 for comparing the first average brightness value and the second average brightness value. In the scenario that the second camera 120 is not blocked, the first image IMG1a and the second image IMG2a are highly similar, such that the first average brightness value will approach to the second average brightness value. For example, the first average brightness value is at a gray level of 183, and the second average brightness value is at a gray level of 186. The first average brightness value and the second average brightness value are similar.

In another scenario that the second camera 120 is blocked, a part of the second image IMG2b may be cover by user's finger, as shown in FIG. 5B. In this case, the brightness values of the second image IMG2b will be shifted (e.g., decreased form the original values), such that the second average brightness value will be differentiate from the first average brightness value. For example, the first average brightness value is at a gray level of 183, and the second average brightness value is at a gray level of 80.

The method 300 is executed for determining whether the second camera 120 is blocked according to a comparison between the first brightness evaluation result and the second brightness evaluation result. In the embodiment, the method 300 executes step S305 for determining whether a comparison difference between the first average brightness value and the second average brightness value exceeds a threshold difference. The threshold difference is a tolerance difference (e.g., 5%, 10%, 15%, 20%, 25%, etc), in order to tolerate the difference due to the interaxial distance and the divergence between characteristics (e.g., sensitivities) of the first camera 110 and the second camera 120.

The second camera 120 is determined to be blocked when the comparison difference between the first average brightness value and the second average brightness value exceeds the threshold difference (e.g., 5%, 10%, 15%, 20%, 25%, etc). However, the threshold difference of the disclosure is not limited to 5%-25%, and it can be any reasonable threshold difference considering the divergence between cameras and related factors. When the second camera 120 is determined to be blocked (e.g., the scenario shown in FIG. 5A and FIG. 5B), the method 300 executes step S306 for generating a blocking notification by the processing unit 140 and showing the blocking notification on the user interface of the display panel 130, so as to notify the user to adjust his gesture while holding the electronic apparatus 100.

In some embodiments, after the step S305 (when the determination is “NO”) or S306 (when the determination is “YES”), the method 300 can further return to the step S301 (not shown in FIG. 3) for sensing the next pair of the first image and the second image, such that the method 300 (including the steps S301˜S306 executed in a loop) can dynamically detect whether the second camera 120 is blocked in real-time.

The first camera 110 and the second camera 120 may have different field of views (FOV), especially when the models of the first camera 110 and the second camera 120 are different. In the embodiment shown in FIG. 4A and FIG. 4B, the second camera 120 has a field of view (FOV) wider than another field of view of the first camera 110. Therefore, the second image IMG2a covers the wider field of view than the first image IMG1a. The mismatched FOVs will lead to a certain deviation while comparing the first average brightness value and the second average brightness value.

Therefore, in some embodiment of the disclosure, if the second camera has a field of view (FOV) wider than another field of view of the first camera as shown in FIG. 4A and FIG. 4B, or FIG. 5A and FIG. 5B, step S303 of calculating the second average brightness value further includes following sub-steps. Firstly, an extraction frame E×F is assigned within the second image IMG2a/IMG2b as shown in FIG. 4B/5B. Ideally, a size and a location extraction frame E×F of the second image IMG2a/IMG2b is configured to be corresponding to the field of view of the first camera 110. Secondly, the pixel data within the extraction frame E×F of the second image IMG2a/IMG2b are extracted. Thirdly, the second average brightness value is calculated from the extracted pixel data within the extraction frame E×F of the second image IMG2a/IMG2b, so as to eliminate the mismatch of FOVs between the first camera 110 and the second camera 120.

On the other hand, if the first camera has a field of view (FOV) wider than another field of view of the second camera, not shown in figures, step S302 of calculating the first average brightness value further includes following sub-steps. Firstly, an extraction frame (not shown in figures) is assigned within the first image IMG1a/IMG1b. Ideally, a size and a location of the extraction frame are configured to be corresponding to the field of view of the second camera 120. Secondly, the pixel data within the extraction frame of the first image IMG1a/IMG1b are extracted. Thirdly, the first average brightness value is calculated from the extracted pixel data within the extraction frame of the first image IMG1a/IMG1b, so as to eliminate the mismatch of FOVs between the first camera 110 and the second camera 120.

In aforesaid embodiments, whether the second camera 120 (i.e., the sub-camera) is blocked or not is determined according to the average brightness values. Aforesaid approach has some limitation of accuracy. For example, the different field of views (FOV) between the first/second images will affect the comparison of the average brightness values. Also, different exposure configurations of the first camera 110 and the second camera 120 may also affect the comparison of the average brightness values. The method for detecting whether one camera within the dual camera configuration is blocked in the disclosure is not limited to the embodiment shown in FIG. 3.

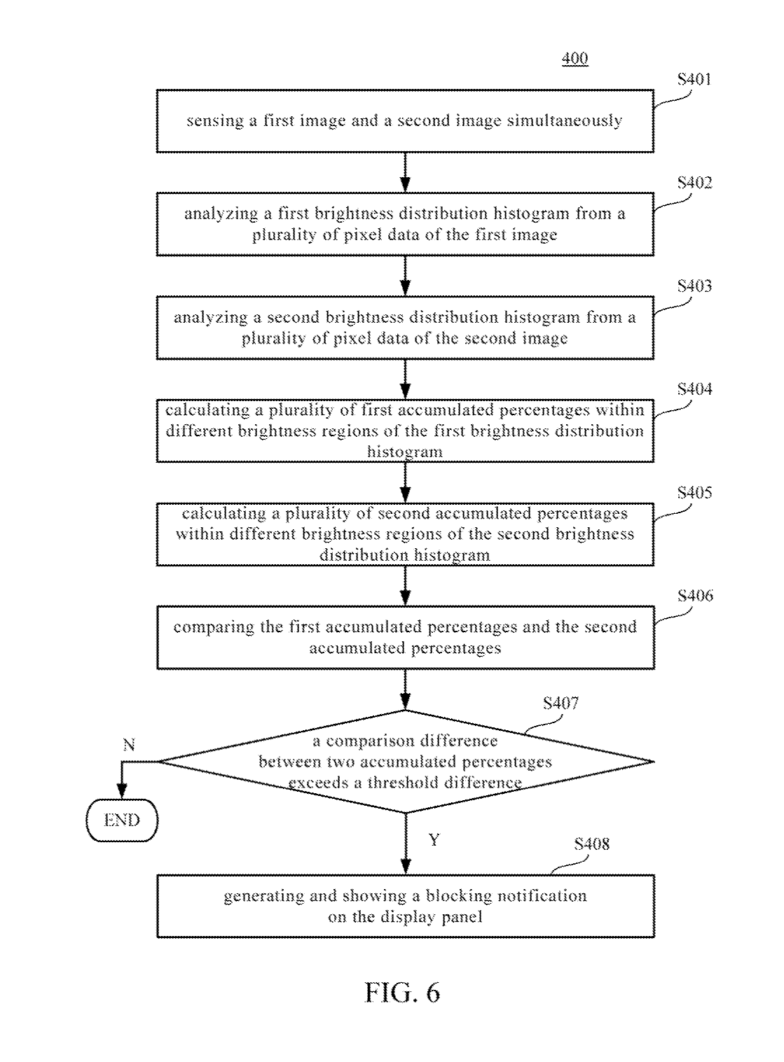

Reference is also made to FIG. 6, which is a flow chart diagram illustrating a method 400 for detecting whether one camera within the dual camera configuration is blocked. As shown in FIG. 6, the method 400 executes the step S401 for sensing a first image by the first camera 110 and a second image by the second camera 120 simultaneously.

As shown in FIG. 6, the method 400 executes the step S402 for analyzing a first brightness distribution histogram from a plurality of pixel data of the first image IMG1a/IMG1b. The method 400 executes the step S403 for analyzing a second brightness distribution histogram from a plurality of pixel data of the second image IMG2a/IMG2b. In addition, the disclosure is not limited to a specific sequence of each step shown in FIG. 6 of this embodiment. For example, the order of the steps S402 and S403 can be swapped in some other embodiments.

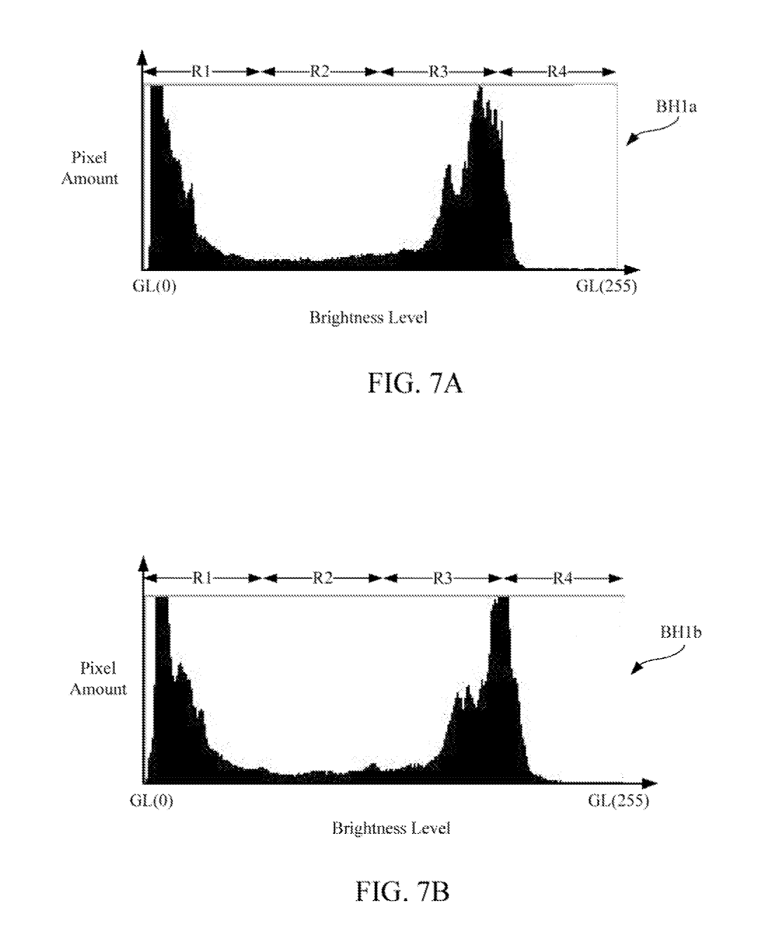

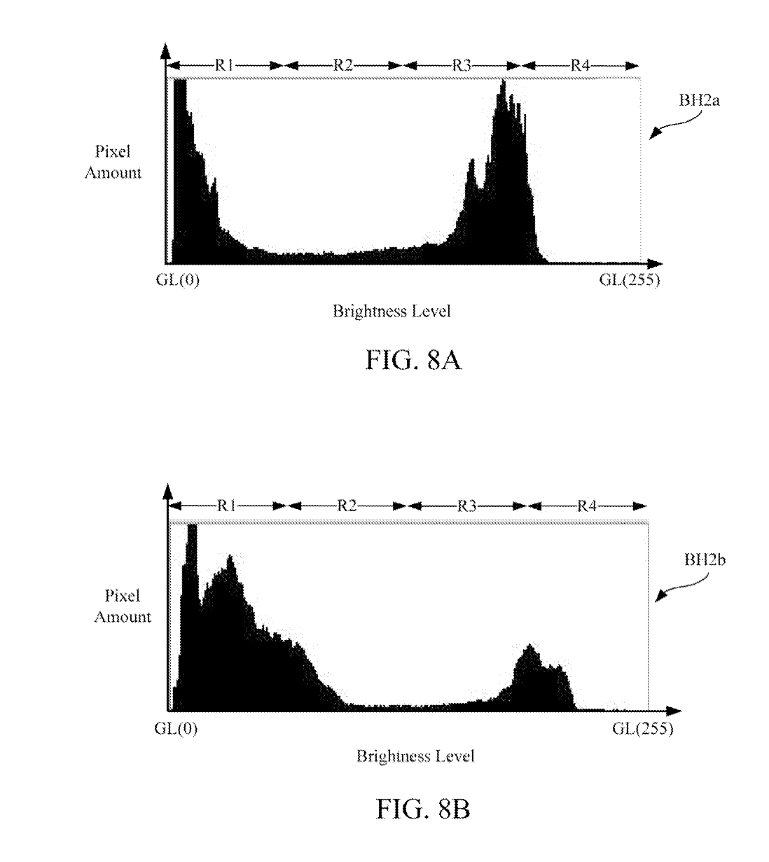

Reference is also made to FIG. 7A, FIG. 7B, FIG. 8A and FIG. 8B, along with FIG. 4A, FIG. 4B, FIG. 5A and FIG. 5B. FIG. 7A illustrates the first brightness distribution histogram BH1a corresponding to the first image IMG1a in FIG. 4A. FIG. 7B illustrates the second brightness distribution histogram BH2a corresponding to the second image IMG2a in FIG. 4B when the second camera 120 is not blocked. FIG. 8A illustrates the first brightness distribution histogram BH1b corresponding to the first image IMG1b in FIG. 5A. FIG. 8B illustrates the second brightness distribution histogram BH2b corresponding to the second image IMG2b in FIG. 5B when the second camera 120 is blocked.

For example, each pixel data in the first image IMG1a/IMG1b has a luminance value. In an embodiment, the luminance value of each pixel in the first image IMG1a/IMG1b can be obtained form the “Y” variable form a YUV (YCbCr) color code of the first image IMG1a/IMG1b. The luminance values of all pixels in the first image IMG1a are counted by statistics to form the first brightness distribution histogram BH1a. The luminance values of all pixels in the first image IMG1b are counted by statistics to form the first brightness distribution histogram BH1b.

Similarly, each pixel data in the first image IMG2a/IMG2b has a luminance value. The luminance values of all pixels in the second image IMG2a are counted by statistics to form the second brightness distribution histogram BH2a. The luminance values of all pixels in the second image IMG2b are counted by statistics to form the second brightness distribution histogram BH2b.

When the second camera 120 is not blocked, the first brightness distribution histogram BH1a shown in FIG. 7A is similar to the second brightness distribution histogram BH2a shown in FIG. 7B. Even though the details within the histograms BH1a/BH1b might be slightly different, the substantial distributions of the histogram BH1a and histogram BH2a are alike.

When the second camera 120 is blocked, the first brightness distribution histogram BH1b shown in FIG. 8A is still the similar to BH1a shown in FIG. 7A, but the second brightness distribution histogram BH2b shown in FIG. 8B is varied significantly. As shown in FIG. 8B, a proportional weight with the lowest gray level, e.g., the brightness region R1 from GL(0) to GL(63), of the second brightness distribution histogram BH2b is increased significantly. Another proportional weight, e.g., the brightness region R2 from GL(64) to GL(127), is also increased. On other hand, the proportional weights, e.g., the brightness region R3 from GL(128) to GL(191) and the brightness region R4 from GL(192) to GL(255), are decreased.

As shown in FIG. 6, the method 400 executes the step S404 for calculating a plurality of first accumulated percentages within different brightness regions R1˜R4 of the first brightness distribution histogram BH1a/BH1b as the first brightness evaluation result. The method 400 executes the step S405 for calculating a plurality of first accumulated percentages within different brightness regions R1˜R4 of the second brightness distribution histogram BH2a/BH2b as the second brightness evaluation result. The method 400 executes the step S406 for comparing the first accumulated percentages and the second accumulated percentages. In addition, the disclosure is not limited to a specific sequence of each step shown in FIG. 6 of this embodiment. For example, the order of the steps S404 and S405 can be swapped in some other embodiments.

In an example when the second camera 120 is not blocked, the first accumulated percentages within the brightness regions R1˜R4 of the first brightness distribution histogram BH1a (FIG. 7A) can be 35%, 7%, 38% and 20%. The second accumulated percentages within the brightness regions R1˜R4 of the second brightness distribution histogram BH2a (FIG. 7B) can be 33%, 7%, 41% and 19%.

In an example when the second camera 120 is blocked, the first accumulated percentages within the brightness regions R1˜R4 of the first brightness distribution histogram BH1b (FIG. 8A) can be 35%, 7%, 38% and 20%. The second accumulated percentages within the brightness regions R1˜R4 of the second brightness distribution histogram BH2b (FIG. 8B) can be 55%, 20%, 11% and 14%.

In the embodiment, the method 300 executes step S407 for determining whether a comparison difference between the first accumulated percentages and the second accumulated percentages exceeds a threshold difference.

In an example when the second camera 120 is not blocked (referring to FIG. 4A, FIG. 4B, FIG. 7A and FIG. 7B), the comparison difference can be calculated by the gaps between the first accumulated percentages and the second accumulated percentages, 2%+0%+3%+1%=6%.

In an example when the second camera 120 is blocked (referring to FIG. 5A, FIG. 5B, FIG. 8A and FIG. 8B), the comparison difference can be calculated by the gaps between the first accumulated percentages and the second accumulated percentages, 20%+13%+27%+6%=66%.

The second camera 120 is determined to be blocked when the comparison difference between the first accumulated percentages and the second accumulated percentages exceeds the threshold difference (e.g., 20%, 30%, 40%, etc). However, the threshold difference of the disclosure is not limited to 20%˜40%, and it can be any reasonable threshold difference considering the divergence between cameras and related factors. When the second camera 120 is determined to be blocked (e.g., the scenario shown in FIG. 5A and FIG. 5B), the method 400 executes step S408 for generating a blocking notification by the processing unit 140 and showing the blocking notification on the user interface of the display panel 130, so as to notify the user to adjust his gesture while holding the electronic apparatus 100.

In some embodiments, after the step S407 (when the determination is “NO”) or S408 (when the determination is “YES”), the method 400 can further return to the step S401 (not shown in FIG. 6) for sensing the next pair of the first image and the second image, such that the method 400 (including the steps S401-S408 executed in a loop) can dynamically detect whether the second camera 120 is blocked in real-time.

In addition, in some embodiment of the disclosure, if the second camera has a field of view (FOV) wider than another field of view of the first camera as shown in FIG. 4A and FIG. 4B, or FIG. 5A and FIG. 5B, step S403 of analyzing the second brightness distribution histogram further includes following sub-steps. Firstly, an extraction frame E×F is assigned within the second image IMG2a/IMG2b as shown in FIG. 4B/5B. Ideally, a size and a location extraction frame E×F of the second image IMG2a/IMG2b is configured to be corresponding to the field of view of the first camera 110. Secondly, the pixel data within the extraction frame E×F of the second image IMG2a/IMG2b are extracted. Thirdly, the second brightness distribution histogram BH1a/BH1b (shown in FIG. 7B or FIG. 8B) is analyzed from the extracted pixel data within the extraction frame E×F of the second image IMG2a/IMG2b, so as to eliminate the mismatch of FOVs between the first camera 110 and the second camera 120.

On the other hand, if the first camera has a field of view (FOV) wider than another field of view of the second camera, the extraction frame (not shown in figures) is assigned within the first image IMG1a/IMG1b. Similar case are explained in aforesaid embodiments and not repeated here again.

In this document, the term “coupled” may also be termed as “electrically coupled”, and the term “connected” may be termed as “electrically connected”. “coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, suitable for an electronic apparatus comprising a first camera and a second camera, the method comprising:
sensing a first image by the first camera and a second image by the second camera simultaneously;
generating a first brightness evaluation result from the first image and a second brightness evaluation result from the second image; and
determining whether the second camera is blocked according to a comparison between the first brightness evaluation result and the second brightness evaluation result.

2. The method of claim 1, wherein the step of generating the first brightness evaluation result and the second brightness evaluation result comprises:
calculating a first average brightness value from a plurality of pixel data of the first image as the first brightness evaluation result; and
calculating a second average brightness value from a plurality of pixel data of the second image as the second brightness evaluation result.

3. The method of claim 2, wherein one of the first camera and the second camera has a field of view (FOV) wider than another field of view of the other camera, the step of calculating the first/second average brightness value from the first/second image with the wider field of view further comprising:
assigning an extraction frame within the first/second image with the wider field of view, the extraction frame corresponding to the narrower field of view of the other camera;
extracting the pixel data within the extraction frame of the first/second image with the wider field of view; and
calculating the first/second average brightness value from the extracted pixel data within the extraction frame.

4. The method of claim 1, wherein the step of generating the first brightness evaluation result and the second brightness evaluation result comprises:
analyzing a first brightness distribution histogram from a plurality of pixel data of the first image;
analyzing a second brightness distribution histogram from a plurality of pixel data of the first image;
calculating a plurality of first accumulated percentages within different brightness regions of the first brightness distribution histogram as the first brightness evaluation result; and
calculating a plurality of second accumulated percentages within different brightness regions of the second brightness distribution histogram as the first brightness evaluation result.

5. The method of claim 4, wherein one of the first camera and the second camera has a field of view (FOV) wider than another field of view of the other camera, the step of analyzing the first/second brightness distribution histogram from the first/second image with the wider field of view further comprising:
assigning an extraction frame within the first/second image with the wider field of view, the extraction frame corresponding to the narrower field of view of the other camera;
extracting the pixel data within the extraction frame of the first/second image with the wider field of view; and
analyzing the first/second brightness distribution histogram from the extracted pixel data within the extraction frame.

6. The method of claim 1, further comprising:
calculating depth information of objects within the first image according to a parallax between the first image and the second image.

7. An electronic apparatus, comprising:
a first camera, configured for pointing in a direction, sensing a first image corresponding to a scene;
a second camera, configured for pointing in the same direction, sensing a second image substantially corresponding to the same scene;
a display panel, configured for displaying the first image as a preview image;
a processing module, coupled with the first camera and the second camera, the processing module is configured for generating a first brightness evaluation result from the first image and a second brightness evaluation result from the second image, and determining whether the second camera is blocked according to a comparison between the first brightness evaluation result and the second brightness evaluation result.

8. The electronic apparatus of claim 7, wherein the first camera is a main camera in a dual camera configuration and the second camera is a subordinate camera in the dual camera configuration, the first image sensed by the first camera is recorded as a captured image.

9. The electronic apparatus of claim 7, wherein the first camera and the second camera are gapped by an interaxial distance, the processing module calculates depth information of objects within the first image according to a parallax between the first image and the second image.

10. The electronic apparatus of claim 7, wherein the processing module is configured for calculating a first average brightness value from a plurality of pixel data of the first image as the first brightness evaluation result, and calculating a second average brightness value from a plurality of pixel data of the second image as the second brightness evaluation result.

11. The electronic apparatus of claim 10, further comprising:
a user interface, displayed on the display panel;
wherein, when a comparison difference between the first average brightness value and the second average brightness value exceeds a threshold difference, the second camera is determined to be blocked, and a blocking notification is generated by the processing module and shown on the user interface.

12. The electronic apparatus of claim 10, wherein, if one of the first camera and the second camera has a field of view (FOV) wider than another field of view of the other camera, the processing module assigns an extraction frame within the first/second image with the wider field of view, the extraction frame corresponds to the narrower field of view of the other camera, the processing module extracts the pixel data within the extraction frame of the first/second image with the wider field of view, the first/second average brightness value of the first/second image with the wider field of view is calculated from the extracted pixel data within the extraction frame by the processing module.

13. The electronic apparatus of claim 7, wherein the processing module is configured for analyzing a first brightness distribution histogram from a plurality of pixel data of the first image, analyzing a second brightness distribution histogram from a plurality of pixel data of the first image, calculating a plurality of first accumulated percentages within different brightness regions of the first brightness distribution histogram as the first brightness evaluation result, and calculating a plurality of second accumulated percentages within different brightness regions of the second brightness distribution histogram as the first brightness evaluation result.

14. The electronic apparatus of claim 13, further comprising:
a user interface, displayed on the display panel;
wherein, when a comparison difference between the first accumulated percentages and the second accumulated percentages exceeds a threshold difference, the second camera is determined to be blocked, and a blocking notification is generated by the processing module and shown on the user interface.

15. The electronic apparatus of claim 13, if one of the first camera and the second camera has a field of view (FOV) wider than another field of view of the other camera, the processing module assigns an extraction frame within the first/second image with the wider field of view, the extraction frame corresponds to the narrower field of view of the other camera, the processing module extracts the pixel data within the extraction frame of the first/second image with the wider field of view, the first/second brightness distribution histogram of the first/second image with the wider field of view is calculated from the extracted pixel data within the extraction frame by the processing module.
